(19) United States
(12) Patent Application Publication
(10) Pub. No.: US 2013/0010023 A1
(43) Pub. Date: Jan. 10, 2013

(54) Printing Apparatus and Printing Method

(75) Inventor: Hirotaka Matsunaga, Matsumoto-shi (JP)

(73) Assignee: SEIKO EPSON CORPORATION, Tokyo (JP)

(21) Appl. No.: 13/544,304

(22) Filed: Jul. 9, 2012

(30) Foreign Application Priority Data
Jul. 7, 2011 (JP) JP2011-150641

(51) Int. Cl. B41J 2/205

(52) U.S. Cl. 347/15

(57) ABSTRACT

A printing apparatus that generates printed matter composed of a plurality of printing layers, wherein the apparatus includes an ink amount selection unit that selects an ink amount that corresponds to each of printing layers using a profile that regulates the correspondence relationship between the component values of input color data and the ink amount in each of the printing layers; and a print execution unit that generates the printed matter by adding layers of printing layers to a medium based on the selected ink amount, wherein in the profile, the ink amount of each printing layer is regulated so that the number of dots that are formed by a first ink and the number of dots that are formed by a second ink with a lower concentration than the concentration of the first ink change according to the printing order of each printing layer.

### BACKGROUND

1. Technical Field

The present invention relates to a printing apparatus that generates printed matter formed by a plurality of printing layers, and a printing method.

2. Related Art

In the related art, there is a printing apparatus that generates printed matter by ejecting ink onto a medium such as paper. The printing apparatus includes an ink tank in which a plurality of inks such as, for example, C (cyan), M (magenta), Y (yellow), and K (black) are filled, and when input color data of the printing target is obtained, the corresponding inks are selected according to the component values in the input color data, and printing is executed.

Further, in the coloring of the printed matter, the desired coloring is realized by combining inks of different colors based on the principle of subtractive color mixing. However, if the difference in the concentrations of the dots that are formed is large, there may be a case when the image quality of the printed matter is negatively influenced. Therefore, a printing apparatus that switches the timing at which ink is ejected onto paper according to density in order to make the image quality of printed matter favorable has been disclosed (for example, refer to JP-A-2009-190394).

One type of printing apparatus forms printed matter using photocurable ink. Photocurable ink is cured and forms dots on a medium by being exposed to the irradiation of light such as ultraviolet rays. In such a printing apparatus, there is a case when printed matter is formed by further adding printing layers to a printing layer that has been formed already. On the other hand, since deterioration of image quality due to differences in the concentration of dots occurs even with printed matter in which printing layers are added and formed, it is necessary to devise some form of solution.

### SUMMARY

An advantage of some aspects of the invention is that a printing apparatus that reduces the deterioration in the image quality of printed matter in a case when printed matter is formed by a plurality of printing layers, and a printing method are provided.

According to an aspect of the invention, there is provided a printing apparatus that generates printed matter composed of a plurality of printing layers on a medium, the apparatus including: an ink amount selection unit that selects an ink amount that corresponds to each printing layer using a profile that regulates the correspondence relationship between the component values of input color data and the ink amount in each of the printing layers; and a print execution unit that generates the printed matter by adding layers of printing layers to a medium based on the selected ink amount, wherein in the profile, the ink amount of each printing layer is regulated so that the number of dots that are formed by a first ink and the number of dots that are formed by a second ink with a lower concentration than the concentration of the first ink change according to the printing order of each printing layer.

In the invention configured as described above, the ink amount selection unit selects the amount of ink that corresponds to each printing layer using a profile that regulates the correspondence relationship between the component values of the input color data and the ink amount in each printing layer. At this time, in the profile that the ink amount selection unit uses, the ink amounts of the printing layers are regulated so that the number of dots that are formed by the first ink and the number of dots that are formed by the second ink change according to the proximity of each printing layer to the medium.

### BRIEF DESCRIPTION OF THE DRAWINGS

The invention will be described with reference to the accompanying drawings, wherein like numbers reference like elements.

FIG. 1 is a block configuration diagram for describing the configuration of a printing apparatus.

FIG. 2 is another block configuration diagram for describing the configuration of a printing apparatus.

FIG. 3 is a flowchart that illustrates the creation of a color correction LUT that is used in the printing apparatus.

FIGS. 4A and 4B are views that describe the creation of a profile.

FIG. 5 is a flowchart that describes the printing method that is executed by the printing apparatus.

FIGS. 6A to 6C are views that describe printed matter that is printed by the printing apparatus.

FIGS. 7A and 7B are views that describe layer-specific LUTs that are created according to a second embodiment.

FIGS. 8A and 8B are views that describe printed matter that is created according to the second embodiment.

### DESCRIPTION OF EXEMPLARY EMBODIMENTS

Embodiments of the invention will be described below according to the order below.

### 1. First Embodiment

### 2. Second Embodiment

### 3. Other Embodiments

### 1. First Embodiment

### 1.1. Configuration of Printing Apparatus

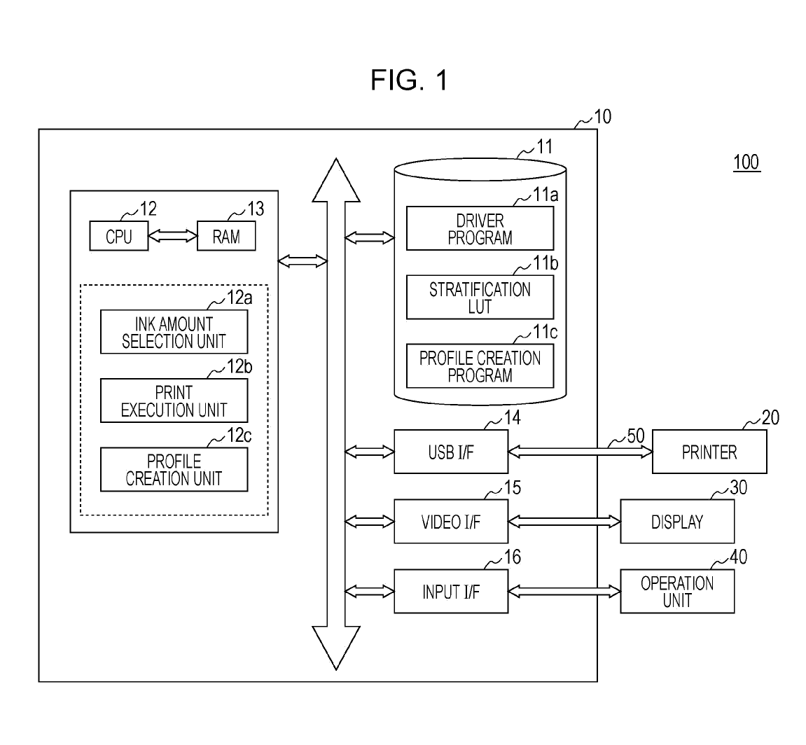

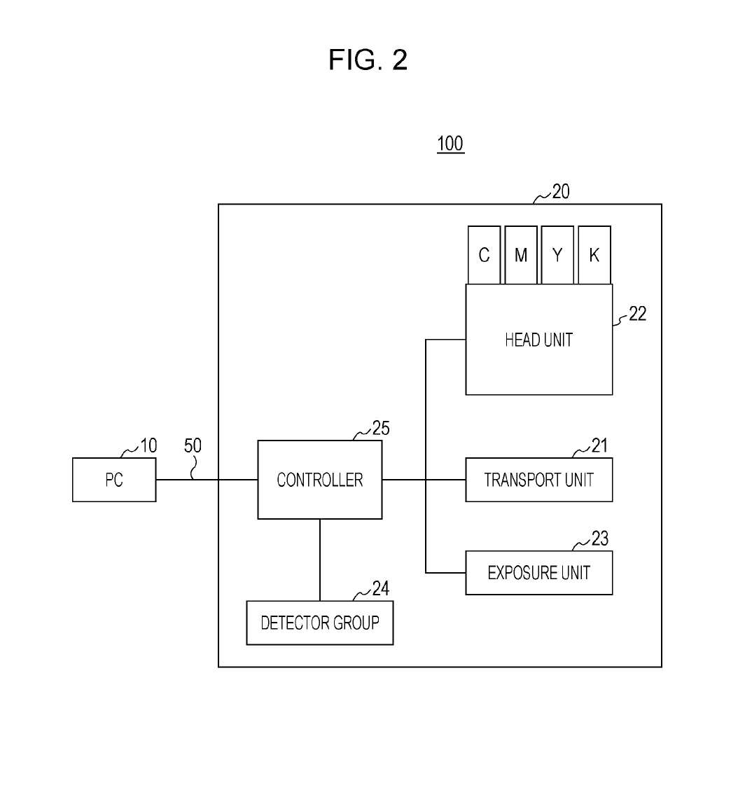

A first embodiment that realizes the printing apparatus according to the embodiments of the invention will be described below with reference to the drawings. FIGS. 1 and 2 are block configuration diagrams for describing the configuration of a printing apparatus 100. In the embodiment, the printing apparatus 100 is configured by a personal computer (hereinafter also referred to as a PC) 10 and a printer 20 being connected to a cable 50.

The PC 10 includes a recording unit 11, a CPU (Central Processing Unit) 12, a RAM (Random Access Memory) 13, a USBI/F (Universal Serial Bus Interface) 14, a video I/F 15, an input I/F 16, and the like. Each unit is connected through a bus, and receives integrated control from the CPU 12. Further, the recording unit 11 is realized by a hard disk drive (HDD), for example, and has programs and data for causing the CPU 12 to realize various functions recorded therein. In the embodiment, a driver program 11a for performing printing, a layer-specific LUT (Look Up Table) 11b, and a profile creation program 11c for creating the layer-specific LUT 11b are recorded on the recording unit 11. Here, the layer-specific LUT 11b is the color profile that is used when the printing apparatus 100 prints each layer that configures the printed matter.

The PC 10 is connected to a display 30 via the video I/F 15, and is connected to an operation unit 40 such as a keyboard or a mouse via the input I/F 16. Further, the PC 10 operationally functions as an ink amount selection unit 12a that generates ink amount data by executing a computation according to the driver program 11a and controlling the printer 20 via the USBI/F 14 and the like and a print execution unit 12b that converts the ink amount data into raster data to cause the printer 20 to execute printing. Furthermore, the CPU 12 operationally functions as a profile creation unit 12c that creates layer-specific LUTs 11b that are layer-specific by executing the profile creation program 11c.

The printer 20 forms an image on a medium by ejecting ultraviolet curable ink (photocurable ink, hereinafter also referred to as UV ink or simply ink) that is cured by the irradiation of ultraviolet rays (hereinafter also referred to as UV). The UV ink is prepared by adding adjuvants such as a polymerization inhibitor or a surfactant to a mixture of an oligomer or monomer with photopolymerization-curability, a photopolymerization initiator, and pigments. Therefore, when the UV ink is exposed to UV irradiation, a photopolymerization reaction occurs, and the UV ink is cured on the medium to form dots.

The printer 20 includes a transport unit 21, a head unit 22, an irradiation unit 23, a detector group 24, and a controller 25. Toners of each color of C (cyan), M (magenta), Y (yellow), and K (black) are connected to the head unit 22 to be detachable, and the ink that is supplied from the toners is ejected to form printed matter. Here, the UV ink described above is charged in the toners. Further, the transport unit 21, the head unit 22, the irradiation unit 23, and the detector group 24 are respectively connected to the controller 25, and receive integrated control from the controller 25. Furthermore, the controller 25 can connect to the USBI/F 14 of the PC 10 through the cable 50, and receives raster data from the PC 10.

Further, the irradiation unit 23 irradiates ultraviolet rays on the medium in order to cause the UV ink that is ejected from the head unit 22 to be cured. The UV ink that is ejected onto the medium therefore begins to be cured by being exposed to the irradiation of ultraviolet rays from the irradiation unit 23. Further, since the printer 20 uses UV ink, there is a limit to the amount of ink that is ejected in one pass. Here, one pass is the period in which the UV ink is ejected while the paper is transported from the front end in the transport direction to the back end by the transport unit 21. In the embodiment, the amount of ink that is ejected in one pass is limited in consideration of stability until the UV ink is cured, the ejection ability of the print head, the recording properties of the paper that is used, the resolution of the formed image, and the like. Therefore, in a case when printed matter that is formed with one layer does not have the desired reproduction color gamut, there may be a case when the printed matter is formed by adding layers a plurality of times. Hereinafter, a layer formed with UV ink which is printed in one pass is referred to as a printing layer, or may be referred to simply as a layer.

### 1.2. Creation of Profile

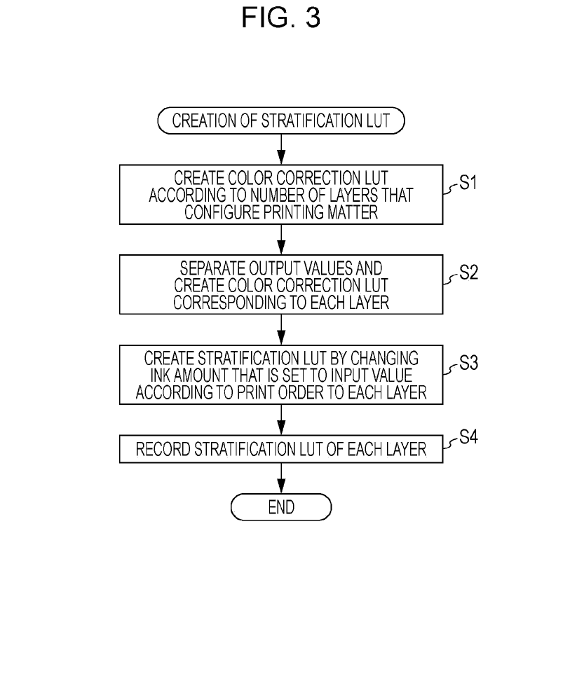

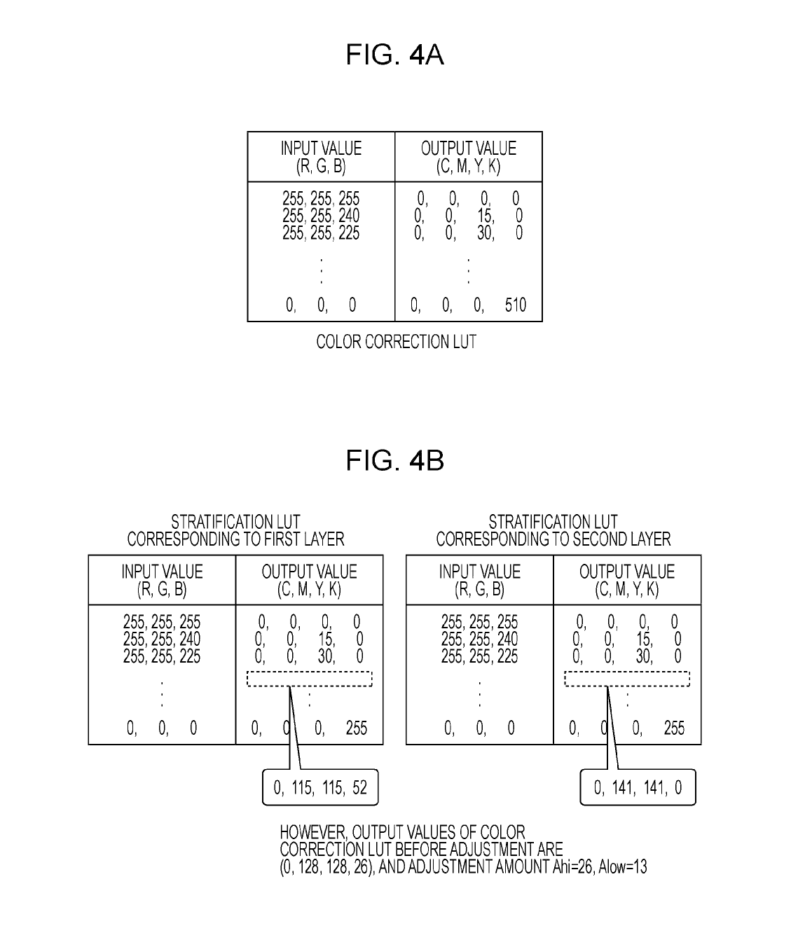

FIG. 3 is a flowchart that illustrates the creation of a layer-specific LUT 11b that is used in the printing apparatus 100. Further, FIGS. 4A and 4B are views that describe the creation of a profile. Here, the profile creation process of the invention is realized through the process illustrated in FIG. 3.

The layer-specific LUT 11b created by the process illustrated in FIG. 3 is a table in which the color component values (sRGB color space values) of the image data (input color data) and the gradation values of the ink amounts (C, M, Y, and K) that the printer 20 ejects are associated. Here, the ink gradation values indicate the ink amount of a predetermined color with a value between 0 and 255. The layer-specific LUT 11b is created according to the number of layers that configure the printed matter. For example, in a case when the printer 20 forms the printed matter by adding two printing layers, the PC 10 provides the recording unit 11 with a color correction LUT (layer-specific LUT) that corresponds to each printing layer. Creation of a layer-specific LUT will be described below.

In step S1 of FIG. 3, the PC 10 (profile creation unit 12c) creates a color correction LUT that forms the basis of the layer-specific LUT 11b. The color correction LUT is a table in which a color component value of the device dependence space (sRGB color space in the embodiment) and the ink amount (CMYK) are corresponded to each other. As illustrated in FIG. 4A, the color correction LUT has each color component value of R, G, and B recorded as input values, and ink gradation values (C, M, Y, and K) are correspondingly recorded as output values. In the embodiment, the ranges of the input values are 0≦R≦255, 0≦G≦255, and 0≦B≦255 to match the reproduction color gamut of the display 30, and the input values are obtained as 16 address points that are arranged with equal intervals on an axis. Further, as the output value, an ink gradation value according to the number of layers of the printer matter is set. For example, in a case when the ink gradation value that can be set for one layer is between 0 and 255, with a color correction LUT that corresponds to the printing apparatus 100 that forms the printed matter with two layers, the ink gradation value is set as an output value between 0 and 510 (255×2) on each input value. Here, the relationship between the input value and the output value is regulated so that both values that are converted in a color space of the same color (for example, CIELA color space) are close.

In step S2, the PC 10 separates the output value of the color correction LUT generated in step S1 according to the characteristics of each layer and generates a new color correction LUT according to each layer. For example, in a case when printed matter is formed with two layers, an output value (ink gradation value) taking into consideration the ink amount that can be set for each layer is set for the input value that is set between 0≦R≦255, 0≦G≦255, and 0≦B≦255 in the newly generated color correction LUT. Here, the ink amount that can be set for each layer is set, for example, according to the ink amount that can be imprinted (imprint limit value) when each layer is formed on paper. Therefore, in a case when the amount of ink that can be imprinted when forming two layers is less than the amount of ink that can be imprinted when forming one layer, there may be a case when the range of the output value of the color correction LUT that corresponds to the two layers is narrower than the range of the output value of the color correction LUT that corresponds to the one layer. In the embodiment, description will be made below with a color correction LUT that corresponds to all layers in which the output value can be set in a range of ink gradation value of 0 to 255.

In step S3, the PC 10 creates the layer-specific LUT 11b by changing the ink amount of a high concentration ink and low concentration inks of the color correction LUT according to the order in which the printing layers are printed. In the embodiment, the ink amount is adjusted for the layer-specific LUT that corresponds to a first layer that is printed on the medium first by increasing the high concentration ink and reducing the low concentration inks. Similarly, the color correction LUT for a second layer is adjusted by increasing the low concentration inks and reducing the high concentration ink on the layer-specific LUT 11b of the second layer that is printed next.

Further, the concentration of the ink is determined based on the brightness of each ink color. In a case when the printer 20 uses inks of the four colors of C, M, Y, and K, the difference in brightness in the color space of the same color(CIELAB color space) of each ink increases in order from K<C<M<Y. Therefore, the concentration of ink is greatest for the K ink and smallest for the Y ink (that is, K>C>M>Y). For example, in a case when a high concentration ink is the K ink, inks with a lower concentration than the K ink (C, M, and Y) are all low concentration inks. Similarly, in a case when the high concentration ink is the C ink, inks with a lower concentration than the C ink (M and Y) are both low concentration inks. Further, in a case when the printer 20 includes pale inks (Lc (light cyan) and Lm (light magenta)), the concentrations of the pale inks can be made to be the same as the concentration of Y.

In the embodiment, the high concentration ink is the K (black) ink, and the low concentration inks are the M (magenta) ink and the Y (yellow) ink. Therefore among the ink amounts that are set for the input value of the color correction LUT of the first layer, the ink gradation value of the K ink is increased by Ahi and the ink gradation values of the M ink and the Y ink are lowered by an adjustment amount Alow. Further, among the ink amounts that are set for the input value of the color correction LUT of the second layer, the ink gradation value of the K ink is decreased by the adjustment amount Ahi and the ink gradation value of the U ink is increased by Alow. Here, the adjustment amount Ahi is a parameter that the PC 10 uses in order to adjust the ink gradation value of the high concentration ink. Further, the adjustment amount A low is a parameter that the PC 10 uses in order to adjust the ink gradation values of the low concentration inks.

As illustrated in FIG. 4B, in a case where the adjustment value Ahi=26 and the adjustment amount Alow=13, with the adjusted layer-specific LUT of the first layer, the ink gradation value of the K ink changes from K=26 to K=52, and the ink gradation values of the M ink and the Y ink respectively change from M=Y=128 to M=Y=115. Similarly, with the adjusted layer-specific LUT of the second layer, the ink gradation value of the K ink changes from K=26 to K=0, and the ink gradation values of the M ink and the Y ink respectively change from M=Y=128 to M=Y=141. Here, if the ink adjustment amount Ahi and the adjustment amount Alow are set so that the adjustment amounts of the high concentration ink and the low concentration inks are the same, as a result, since the same number of dots are traded in each layer, the number of dots in the printed matter as a whole does not change, allowing variations in image quality to be suppressed.

Further, the ink gradation value that is set for a given input value must be set within a range without exceeding the ink imprint limit value. Here, the imprint limit value is regulated by (number of dots that are imprinted per unit area)×(mass per dot), and the value changes depending on the medium. In the embodiment, as an example, the imprint limit value of a given layer is 110 percent. Therefore, an ink amount that increases in the adjustment of step S3 must be set within a range without exceeding the imprint limit value.

Furthermore, in step S4, the layer-specific LUT of each layer is recorded in the recording unit 11. Thereafter, in a case when the printer matter is formed with a layer number of two, the PC 10 generates printed matter composed of two layers using the layer-specific LUT of the first layer and the layer-specific LUT of the second layer.

### 1.3. Printing Method

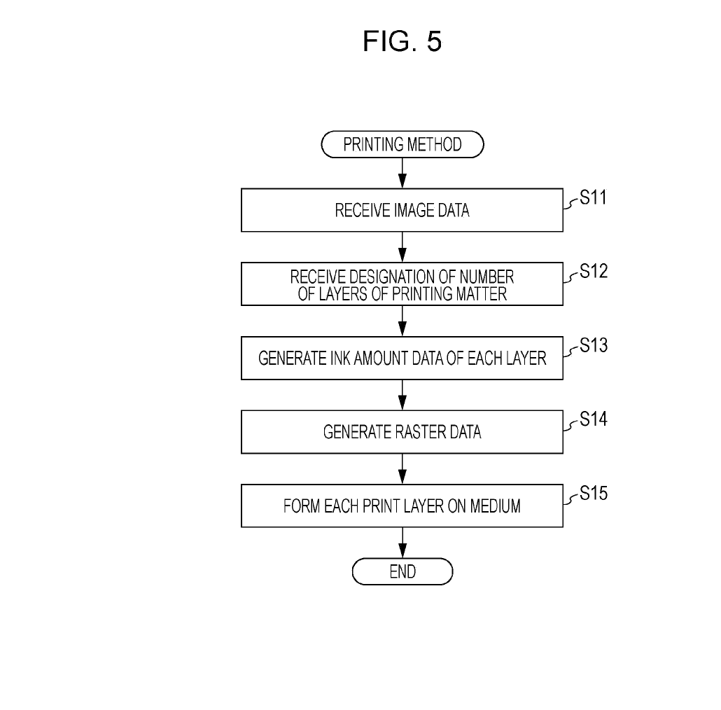

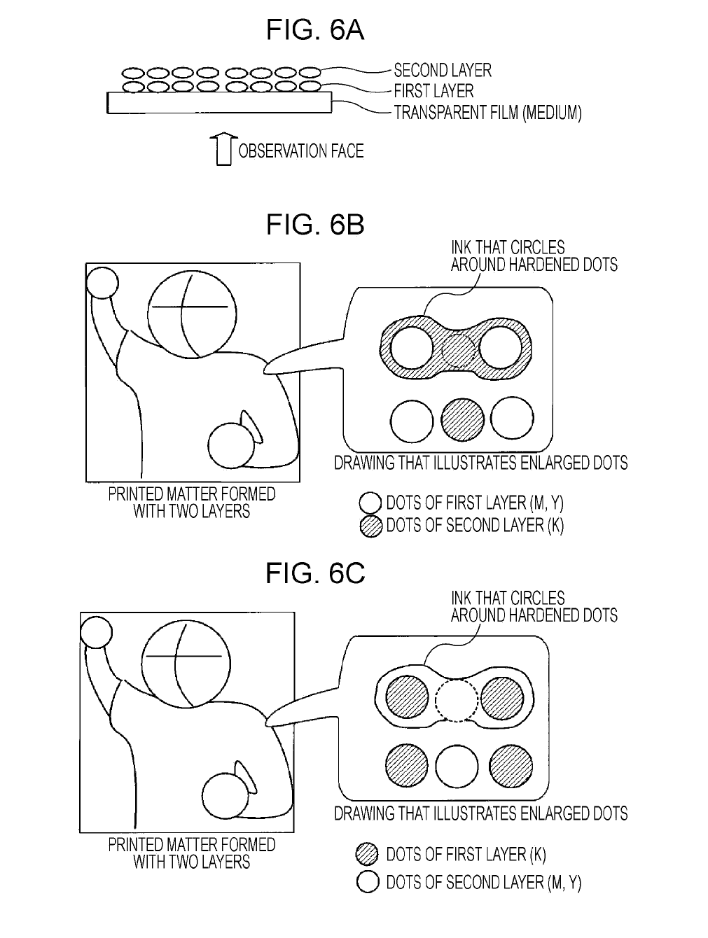

FIG. 5 is a flowchart that describes the printing method that is executed by the printing apparatus 100. Further, FIGS. 6A to 6C are views that describe printed matter that is printed by the printing apparatus 100.

In step S11, the PC 10 (ink amount selection unit 12a) receives image data (input color data) for printing printed matter. The image data is configured by color component values in RGB color space according to the resolution number. Here, the image data can be obtained, for example, by the PC 10 executing an application program (not shown).

In step S12, the PC 10 receives the designation of the number of layers that configure the printed matter. That is, when a user operates a UI screen (not shown) through the operation unit 40 and inputs the number of layers that configure the printed matter, the PC 10 receives the input number of layers. A case when the number of layers that configure the printed matter is two will be described below.

In step S13, the PC 10 generates ink amount data for forming each layer from the image data. The PC 10 converts the color component values that are included in the image data into ink amount data that forms the first layer using the layer-specific LUT of the first layer. Further, the PC 10 converts the color component values that are included in the image data into ink amount data that forms the second layer using the layer-specific LUT of the second layer. In the embodiment, the ink amount data of the first layer and the ink amount data of the second layer are obtained based on the same image data obtained by the PC 10. Further, since in the layer-specific LUT of the first layer and the layer-specific LUT of the second layer, the ink amounts of the K ink, the C ink, and the Y ink are adjusted, the ink gradation values of the K ink, the C ink, and the Y ink are different even for the ink amount data that corresponds to the first layer and the ink amount data that corresponds to the second layer. That is, in the ink amount data of the first layer, the output value of the K ink is greater than in the ink amount data of the second layer by the adjustment Ahi×2, and the output values of the C ink and the Y ink are less by the adjustment amount Alow×2.

In step S14, the PC 10 generates raster data from the ink amount data of each layer. The raster data is the ink gradation value (a value from 0 to 255 in the embodiment) that the ink amount data designates which is converted into a binary value that the printer 20 can use. The PC 10 generates raster data that corresponds to each layer from the ink amount data that corresponds to each layer. Through such a step, the ink amount selection process is realized.

In step S15, the PC 10 (print execution unit 12b) outputs the raster data to the printer 20 and causes the printed matter to be generated. Therefore, as illustrated in FIG. 6A, the printer 20 forms the first layer by irradiating ultraviolet rays from the irradiation unit 23 after ejecting UV ink that is designated by the raster data for the first layer on a face on the opposite side as the observation side of a transparent film. Next, the printer 20 forms the second layer by irradiating ultraviolet rays from the irradiation unit 23 after ejecting UV ink that is designated by the raster data for the second layer from the opposite side to the observation face of the transparent film and above the first layer. Therefore, printing layers are formed on the opposite face to the observation face in order from the first layer to the second layer. Through such a step, the print execution process is realized.

Here, as a detailed process of generating multi-layered printed matter using the printer 20, after the printer 20 forms the first layer, the second layer may be formed by the transport unit 21 feeding back the transparent film. Otherwise, the second layer may be formed by the user resetting the transparent film in the printer 20.

The characteristics of printed matter that is printed by the printing apparatus 100 will be described. In a case when UV ink is ejected into separated layers, since the ink of the next layer is ejected over dots that are cured first, there may be a case when the shapes of the dots of the next layer are not favorable. When unfavorable dot formation increases, a deterioration in the image quality of the printed matter is induced. Further, in a case when the printed matter is formed with multiple layers, there may be a case when further deterioration in the image quality is induced by the ink that is ejected for the next layer surrounding the dots that are formed for the previous layer and the surrounding ink being cured. As illustrated in FIG. 6B, since the ink that surrounds the dots does not form circular dots, such ink is a cause of image deterioration. Therefore, in a case when the concentration of the ink that surrounds the dots of the previous layer is higher than for the dots, unfavorable dots are more visible, and image deterioration is obvious.

On the other hand, with printed matter that is printed by the printing apparatus 100, as illustrated in FIG. 6C, by increasing the number of K dots that are more noticeable to an observer on the first layer that is close to the transparent film, the number of unfavorable K dots is reduced. Further, by increasing the number of C dots and Y dots with a lower concentration than the K dots on the next layer (second layer) and subsequent layers, even in a case when ink surrounding occurs, the dots on which surrounding has occurred does not stand out to the observer. For example, even in a case when the Y ink surrounds the K dots, since the Y ink is not easily noticeable to the observer, deterioration in the image quality can be suppressed. The first embodiment has been described above.

### 2. Second Embodiment

In the second embodiment, a configuration of forming dots with low concentrations on layers with an earlier printing order and forming dots with high concentrations on layers with a later printing order differs from the first embodiment. In a case when printed matter is formed with multiple layers using photocurable ink, unfavorable formation of high concentration dots tends to occur on layers after the first layer, which tends to cause unfavorable image quality. However, as the number of layers increases, since dots tend to be hidden and do not stand out behind dots that are formed on a previous layer especially for layers with a later printing order, in the second embodiment, the number of high concentration dots is reduced for layers with an earlier printing order so that unfavorable dot formation does not stand out.

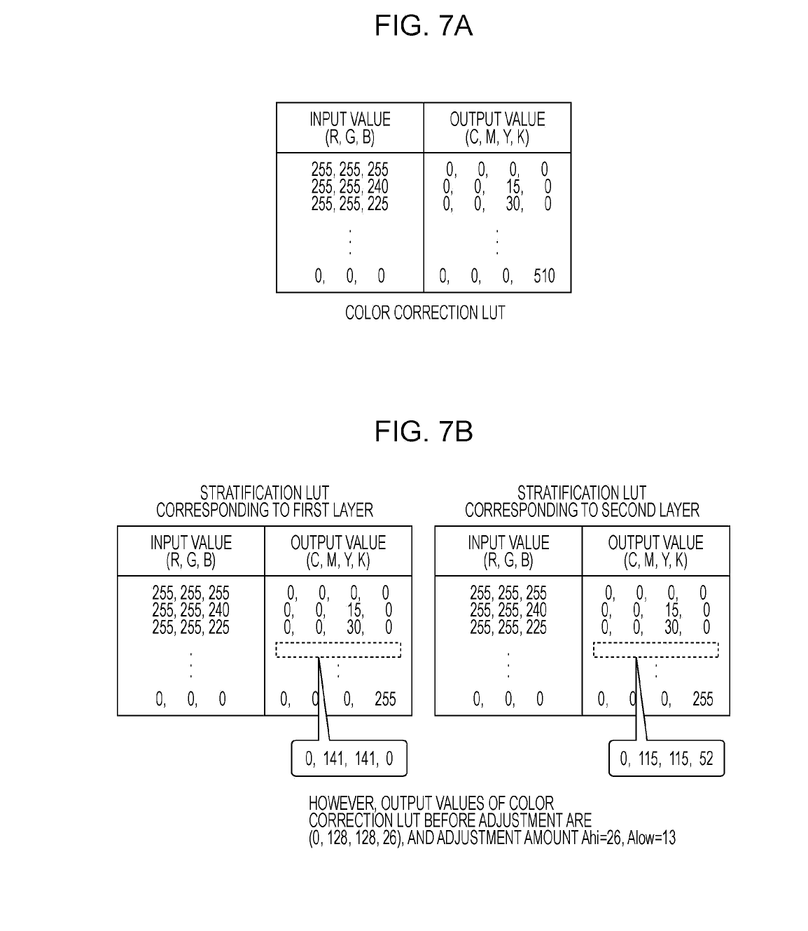

FIGS. 7A and 7B are views that describe layer-specific LUTs that are created according to the second embodiment. In the second embodiment, similarly to the first embodiment, a layer-specific LUT is created by the technique shown in the flowchart of FIG. 3. Description of the creation method of a layer-specific LUT will therefore be omitted.

As illustrated in FIGS. 7A and 7B, a layer-specific LUT is created by performing adjustment of layer-specific ink amounts on a newly formed color correction LUT by separating the output values of the original color correction LUT (FIG. 7A) from the layer-specific LUT according to the second embodiment. In the second embodiment, the PC 10 performs adjustment of the ink amount by increasing the low concentration inks and reducing the high concentration ink in the layer-specific LUT of the first layer. Further, the PC 10 performs adjustment of the ink amount by reducing the low concentration inks and increasing the high concentration ink in the layer-specific LUT of the second layer.

For example, as illustrated in FIG. 7B, if the high concentration ink is K (black) ink and the low concentration inks are M (magenta) and Y (yellow), among the ink gradation values that are set in the input values of the layer-specific LUT of the first layer, the ink gradation value of the K ink is lowered by Ahi and the ink gradation values of the M ink and the Y ink are increased by Alow. Further, among the ink gradation values that are set in the input values of the layer-specific LUT of the second layer, the ink gradation value of the K ink is increased by Ahi and the ink gradation values of the M ink and the Y ink are reduced by Alow. Through the adjustment described above, in the layer-specific LUT of the first layer with respect to the layer-specific LUT of the second layer, the ink gradation value of the K ink is reduced by Ahi×2 and the ink gradation values of the M ink and the Y ink are increased by Alow×2.

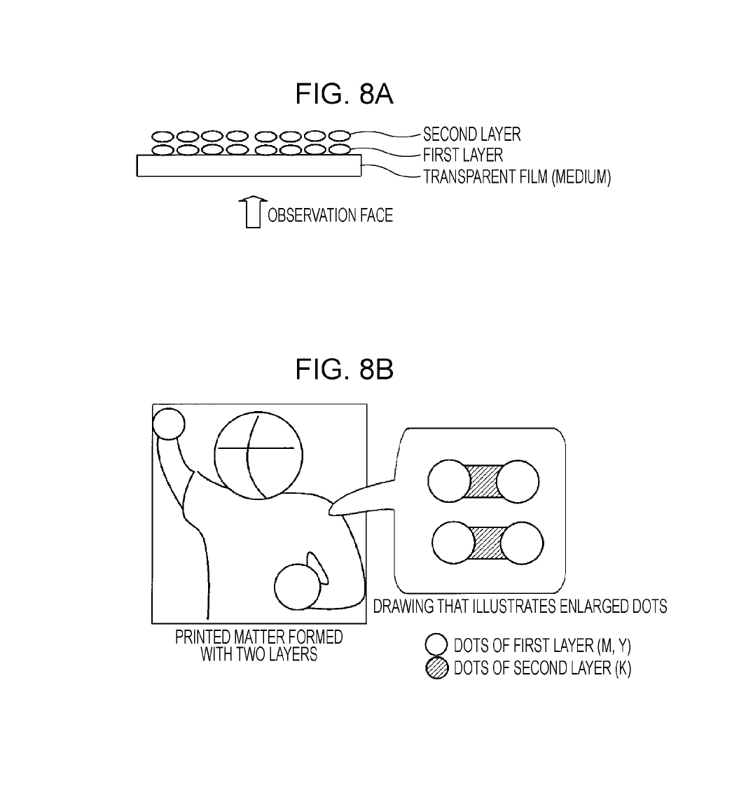

FIGS. 8A and 8B are views that describe printed matter that is created according to the second embodiment.

By generating printed matter using the layer-specific LUT according to the second embodiment, as illustrated in FIG. 8A, the printer 20 forms printed matter in which the first layer and the second layer are overlapped on the opposite face to the observation face of the transparent film. Therefore, in the printed matter, the number of K dots for a layer with an earlier printing order (first layer) is smaller than for a layer with a later printing order (second layer), and the numbers of M dots and Y dots for a layer with an earlier printing order (first layer) are greater than for a layer with a later printing order (second layer).

The characteristics of the printed matter that is generated by the technique according to the second embodiment will be described. With the printed matter that is generated by the technique illustrated in the second embodiment, the number of K dots that are easily noticeable by an observer is reduced in the first layer that is close to the observation face of the transparent film so that unfavorable K dots do not stand out (FIG. 8B). On the other hand, since the total number of dots in the two layers does not change by increasing the number of M dots and Y dots by the amount by which the number of K dots in the first layer was reduced, a change in the image quality can be suppressed. It is therefore possible to suppress deterioration in the image quality even with printed matter that is formed with multiple layers. The second embodiment has been described above.

### 3. Other Embodiments

There are various modification examples for the invention.

The K ink being the high concentration ink is one example, and otherwise, C (cyan) ink may be used in addition to the K ink as the high concentration ink. In such a case, adjustment of the ink amounts of the K dots and the C dots, and of the M ink and the U ink are performed in each layer that forms the printed matter.

Here, needless to say, the invention is not limited to the embodiments described above. While it is needless to say, it is disclosed as an embodiment of the invention that those skilled in the art may:

modify and apply, as appropriate, the combination of members, configurations, and the like that can be mutually substituted which are disclosed in the embodiments described above

modify and apply the combination of members, configurations, and the like that can be mutually substituted as appropriate, which are, while not disclosed in the embodiments described above, techniques of the related art

modify and apply the combination of members, configurations, and the like that can, while not disclosed in the embodiments described above, be conceived by those skilled in the art as substitutes for the members, configurations, and the like that are disclosed in the embodiments described above based on techniques of the related art.

The entire disclosure of Japanese Patent Application No. 2011-150641, filed Jul. 7, 2011 is expressly incorporated by reference herein.

What is claimed is:

1. A printing apparatus that generates printed matter composed of a plurality of printing layers, the apparatus comprising:
an ink amount selection unit that selects an ink amount that corresponds to each of printing layers using a profile that regulates a correspondence relationship between component values of input color data and the ink amount in each of the printing layers; and
a print execution unit that generates the printed matter by adding layers of printing layers to a medium based on the selected ink amount,
wherein in the profile, the ink amount of each printing layer is regulated so that a number of dots that are formed by a first ink and a number of dots that are formed by a second ink with a lower concentration than a concentration of the first ink change according to a printing order of each printing layer.

2. The printing apparatus according to claim 1,
wherein in the profile, the ink amount of each printing layer is regulated so that the earlier in the printing order a printing layer is, the greater the number of dots formed by the first ink and the smaller the number of dots formed by the second ink.

3. The printing apparatus according to claim 1,
wherein the medium is a transparent medium, and
in the profile, the ink amount of each printing layer is regulated so that the earlier in the printing order a printing layer is, the smaller the number of dots formed by the first ink and the greater the number of dots formed by the second ink.

4. The printing apparatus according to claim 1,
wherein the concentration of the ink is determined according to a brightness of an ink color.

5. The printing apparatus according to claim 1,
wherein the first ink is black ink.

6. The printing apparatus according to claim 1,
wherein the second ink is yellow ink.

7. A printing method of generating printed matter composed of a plurality of printing layers, comprising:
generating a profile that regulates a correspondence relationship between component values of input color data and an ink amount of each printing layer so that a number of dots that are formed by a first ink and a number of dots that are formed by a second ink with a lower concentration than a concentration of the first ink change according to a printing order of each printing layer;
selecting the ink amount that corresponds to each of the printing layers using the profile; and
generating printed matter by adding layers of printing layers on a medium based on the selected ink amount.
